(19) United States
(12) Patent Application Publication
(10) Pub. No.: US 2025/0290582 A1
(43) Pub. Date: Sep. 18, 2025

(54) Lockout Shaft

(71) Applicant: Jayson Dumenigo, Canyon Country, CA (US)

(72) Inventor: Jayson Dumenigo, Canyon Country, CA (US)

(21) Appl. No.: 18/608,316

(22) Filed: Mar. 18, 2024

(51) Int. Cl. F16L 33/08; F16B 2/06; F16L 21/06

(52) U.S. Cl. CPC F16L 33/08; F16B 2/06; F16L 21/065

(57) ABSTRACT

An example embodiment of a lockout shaft is provided that is used in combination with a tensioning device, such as a manual or automatic ratchet, which is used to tighten (or release) webbing that secures an item. The lockout shaft is capable of providing additional strength to the holding power of the webbing, with the additional strength being equal or greater to the strength of the webbing itself.

### TECHNICAL FIELD

The disclosure generally pertains to tensioning devices, and more particularly to a lockout shaft that works in combination with a tensioning device such as a webbing ratchet, to provide a significant increase in the strength of the webbing when the webbing is maintaining an item.

### BACKROUND ART

There are many scenarios when a person must secure an item to another item, a structure or other locations. For some of these, the most effective means of securement is to utilize webbing that is wrapped around an item to be secured and the securing structure or locations. To ensure a strong securement of the item, the webbing is typically tightened by use of a tensioning device such as a manual or powered ratchet.

As long as the webbing is correctly placed on the item, structure/location, as well as the ratchet, it is usually possible to obtain a strong securement. For most securing jobs this amount of securement is sufficient, but there are cases that require an above normal strength securement. These cases often involve complicated or fragile (and expensive) items, and/or when there is a serious chance of injury or death of a person occurring if a securement fails.

There have been attempts to provide strength improving products or devices for webbing; most commonly these include clamps or similar types of secondary securing. It would be extremely beneficial to provide a type of add-on device that is especially designed to work in combination with a tensioning device that is especially designed to work in combination with a tensioning device, such as a ratchet. The device would be capable of adding strength that is at least equal to the existing strength of the webbing, and optionally would provide a significant increase in strength. The device would not interfere with the operation of the tensioning device/ratchet and would be easy to implement.

A search of the prior art did not disclose any literature or patents that read directly on the claims of the instant disclosure. However, the following U.S. patents are considered related:
U.S. Pat. No. Inventor Issued
U.S. Pat. No. 5,214,982 Sheih Jun. 1, 1993
U.S. Pat. No. 5,235,867 Wortmann, et al Aug. 17, 1993
U.S. Pat. No. 6,038,893 Neeley, et al Mar. 21, 2000
U.S. Pat. No. 9,208,264 Dudgeon, et al Dec. 8, 2015

The U.S. Pat. No. 5,214,982 patent discloses a ratchet wheel having a locking device that includes a ratchet wheel disposed pivotally in the housing such that one end of the axle couples with an external rotating object, a braking member having a shank provided with a wedge angle and with a pivot, and a lock. The pivot is coupled with the housing so that it moves between a first position and a second position. When the braking member is at the first position, the wedge angle meshes with the ratchet wheel, and when the braking member is at a second position, its wedge angle disengages from the ratchet wheel.

The U.S. Pat. No. 5,235,867 patent discloses a cable tensioning system for removing slack from a brake cable or the like and includes a resettable holdout arrangement for retaining an adjuster ratchet in a spring-biased caged condition. Three embodiments are characterized by the use of an axially displaceable lockout pin that defines an abutment in the path of the adjuster ratchet and a lockout spring having an arm portion adapted to extend into a corresponding notch within the periphery of the adjuster ratchet.

The U.S. Pat. No. 6,038,893 patent discloses a locking device for use in connection with an energy controlling apparatus, such as a valve or regulator, to prevent changing the position of a rotatable shaft of the apparatus that controls the amount of energy that passes through the apparatus. The locking device includes a handle to manually set the position of the shaft; it also is a gear that is rotatably mounted in the handle and is fixed to the shaft of the apparatus. A first locking mechanism mechanically and selectively couples the handle and gear through a key access to the lock.

The U.S. Pat. No. 9,208,264 patent discloses a lockout device includes a body, a clamp and a cover. The body includes a recess and a first lock passage extending from a first opening in an upper surface to a second opening in a rear surface. The clamp assembles with a clamp retaining portion of the body. The cover is connected with the body and is movable between a lockout position covering a portion of the clamp and a release position uncovering the clamp. The cover includes first and second cutouts. When the cover is locked, the cutouts align with the openings to permit insertion of a lock member.

For background purposes and indicative of the art to which the invention relates, reference may be made to the following remaining patents found in the patent search.
U.S. Pat. No. Inventor Issued
U.S. Pat. No. 5,771,996 Marasco Jun. 30, 1998
U.S. Pat. No. 9,341,047 Turick, et al May 17, 2016
U.S. Pat. No. 10,148,038 Cunningham, et al Dec. 4, 2018
U.S. Pat. No. 10,179,383 Keith, et al Jan. 15, 2019
2014/0167391 Elliot, et al May 19, 2014
2023/0193978 Enger, et al Jun. 6, 2023

### SUMMARY

Example embodiments of a lockout shaft are disclosed that are used in combination with a tensioning device, such as a manual or automatic ratchet, which is used to tighten (or release) webbing that secures an item. The lockout shaft is capable of providing additional strength to the holding power of the webbing, with the additional strength being equal or greater to the strength of the webbing itself.

The lockout shaft is comprised of a hollow cylindrical (or other shaped) body with an outer surface, an inner surface, a first end having an oval opening, a second end having an oval opening, a slot extending along the body from the first end to the second end, at least one bore on the first end, and at least one bore on the second end.

Slidably inserted into the body is an oval wedge member with a first section having a first end, a second end, a half-oval outer surface, an inner surface, and a cavity centrally located on the first section. A second section has a first end, a second end, a half-oval outer surface, an inner surface, and an outward-extending tab dimensioned to fit into the cavity on the first section. The wedge member is designed so that when the inner surfaces are pressed onto each other, and the two sections are secured together, the two half-oval outer surfaces create a fully oval member. Attachment means such as a screw, bolt or wire are inserted into openings and are used to secure the two sections together. Other attachment means may include non-limiting examples of a pin, adhesive, clamp, strap, band, and/or welding.

At least one ratchet gear is slidably inserted over/onto the body. The ratchet gear has an inner surface, an outer surface, perimeter teeth and a center opening with an internal oval section that functions as a cap over the oval open end on the wedge member when the wedge member is within the body.

An end of length of webbing is wrapped around the oval wedge member, with the webbing exiting through the slot on the body. The locknut shaft then interfaces with the tensioning device (ratchet) and is ready for use.

In view of the above disclosure, the primary object of the invention is to provide a lockout shaft that can significantly increase the operational strength of webbing that is tightened by a tensioning device such as a ratchet.

In addition to the primary object of the invention it is also an object of the invention to provide a lockout shaft that:
is easy to use,
can be used with various tensioning devices/ratchets,
can improve safety and prevent injury when using webbing for securing an item(s),
is easy to install on a tensioning device/ratchet,
is robust and long lasting
can be sold along with a tensioning device/ratchet, or as an after-market product,
has few components and thereby requires little or no maintenance, and
is cost effective from both a manufacturer's and end user's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic view of an example embodiment of a lockout shaft with ratchet gears and a length of webbing extending from a slot in a cylindrical body.

FIG. 2 is an orthographic view of an example embodiment of the lockout shaft with two ratchet gears.

FIG. 3 is an orthographic view of an example embodiment of the lockout shaft with one ratchet gear.

FIG. 4 is an orthographic view of an example embodiment of the lockout shaft's cylindrical body.

FIG. 5 is an orthographic view of an example embodiment of the lockout shaft's two-piece wedge member.

FIG. 6 is an elevational end view of an example embodiment of the lockout shaft's wedge member.

FIG. 7 is an elevational end view of an example embodiment of the lockout shaft's cylindrical body and the oval wedge member within an oval interior of the body.

FIG. 8 is an elevational sideview of an example embodiment of a ratchet gear with a center opening having an internal oval section maintained by a support arm.

FIG. 9 is an elevational view of an example embodiment of the lockout shaft with the oval wedge member and ratchet gear.

FIG. 10 is a flow diagram of an example embodiment of a method of securing webbing in a lockout shaft.

### DETAILED DESCRIPTION

The disclosure is presented in terms of a preferred embodiment with two design configurations of a lockout shaft. Both design configurations of the lockout shaft are used in combination with a tensioning device such as a manual or automatic ratchet which is used to tighten (and release) a length of webbing that secures an item to a location, a structure, or other place. Typical webbing provides a significant amount of strength when holding an item, but the lockout shaft provides additional strength that is at least equal to the strength of the webbing itself. This is due to the unique way that the webbing is maintained in the lockout shaft, with the webbing wrapping back over itself around an oval trajectory. Essentially, the main function of the lockout shaft is to secure webbing within a tensioning device at equal or greater strength to the breaking strength of the webbing.

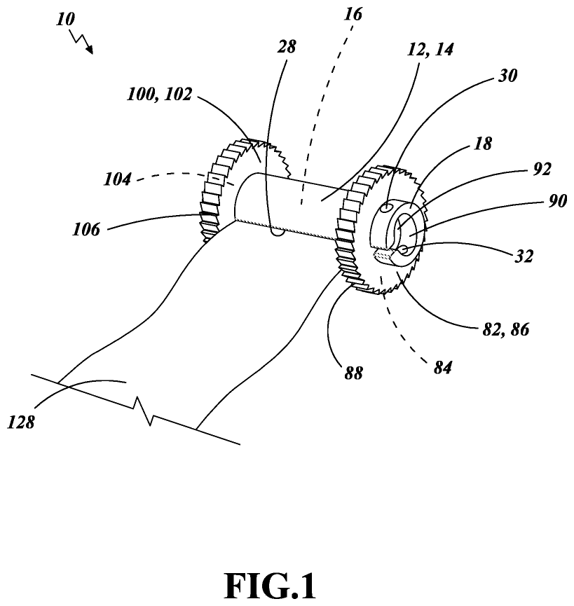

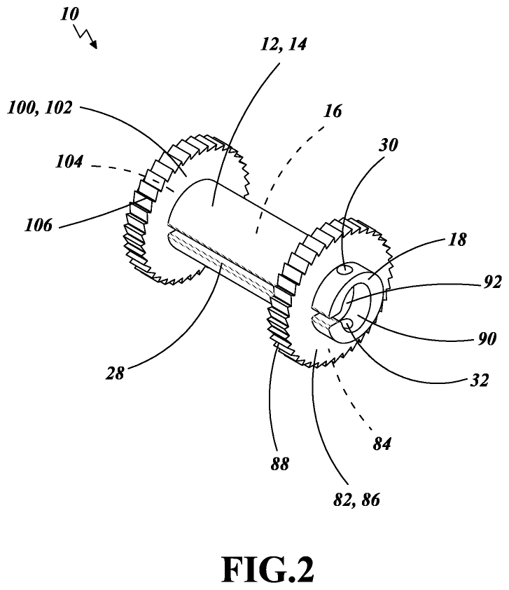

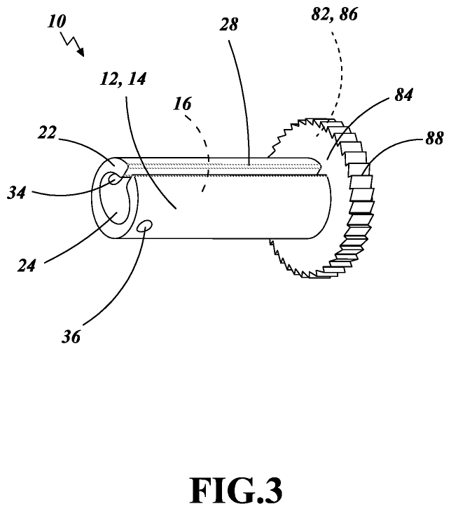

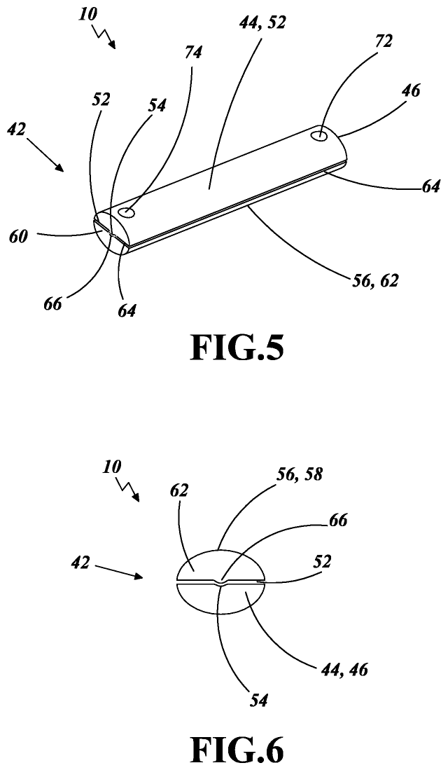

As previously disclosed, lockout shaft 10, as shown in FIGS. 1-8, has two design configurations. The first design configuration, as shown in FIG. 2, comprises hollow cylindrical body 12 with outer surface 14, inner surface 16, first end 18 with oval opening 20 and second end 22 with oval opening 24. Longitudinally extending from first end 18 to second end 22 on cylindrical body 12, is slot 28 where the end of a length of webbing 128 is inserted and extends from. Adjacent first end 18 is at least one bore 30, and adjacent second end 22 is also at least one bore 34.

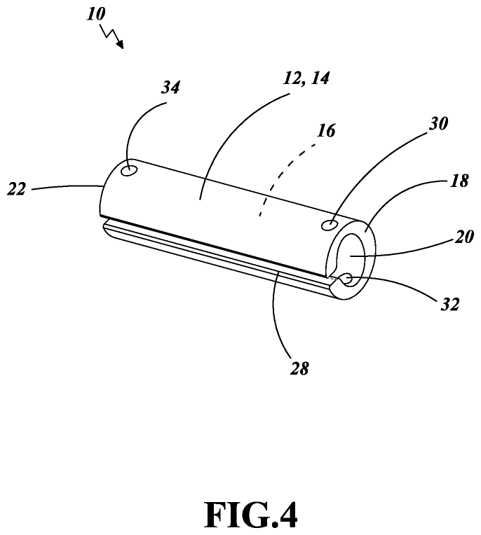

Lockout shaft 10 also comprises two-piece oval wedge member 42, as shown in FIGS. 4-7, with the two pieces held together by an attachment means which may comprise at least one screw, bolt, wire or other means. Also, the attachment means may have a self-tapping (i.e., pointed) tip that passes through webbing 128 within wedge member 42.

Oval wedge member 42 itself is comprised of first section 44 with first end 46, second end 48, half-oval outer surface 50, inner surface 52 and cavity 54 preferably at the substantial center of the first section 44. Second section 56 has first end 58, second end 60, half oval outer surface 62, inner surface 64, outward extending tab 66 that is dimensioned and located to fit into cavity 54 on first section 44. Additionally, first section 44 has at least one opening 68 and second section 56 also has at least one opening 72.

At least one ratchet gear 82 is located on and around cylindrical body 12 at one end. Ratchet gear 82, as shown in FIGS. 1-3 and 8, is dimensioned to slidably fit over one end of cylindrical body 12 and to remain on cylindrical body 12. Ratchet gear 82 comprises inner surface 84, outer surface 86, perimeter teeth 88 that are designed to slide over the body, slotting into place and capping the interior of the body, center opening 90 that corresponds to the dimensions of cylindrical body 12 which allows ratchet gear 82 to slide over and onto cylindrical body 12 and internal oval section 92 that is located adjacent the end of the cylindrical body 12. Ratchet gear 82 is maintained in place on cylindrical body 12 by at least one securing pin that may be inserted into one of bore 30, 32, 34, 36 on cylindrical body 12. Extending into center opening 90 is internal oval section 92 that is secured to an inner perimeter of center opening 90 of ratchet gear 82 by support arm 94, as shown in FIG. 8. Ratchet gear 82 is a component of a tensioning device quick-release assembly, and functions as a cap for wedge member 42, as a “key” for lockout shaft 10, thus maintaining wedge member 42 within cylindrical body 12, and stops crushing or biting of webbing 128 within lockout shaft 10.

The second design configuration of the lockout shaft 10 is similar to the first design configuration with several differences as disclosed below. The second design configuration of lockout shaft 10 is also used in combination with a tensioning device such as a manual or automatic ratchet which is used to tighten (and release) webbing 128 in lockout shaft 10 thereby securing webbing within a tensioning device at equal or greater strength to the webbing breaking strength.

The second design of lockout shaft 10 is comprised of hollow cylindrical body 12 with outer surface 14, inner surface 16, first end 18 having an oval opening 20, second end 22 having oval opening 24, and slot 28 longitudinally extending from first end 18 to second end 22. Slot 28 is dimensioned to accept an end of a length of webbing 128. Located adjacent to first end 18 is first bore 30 and second bore 32. and located adjacent to second end 22 is also first bore 34 and second bore 36.

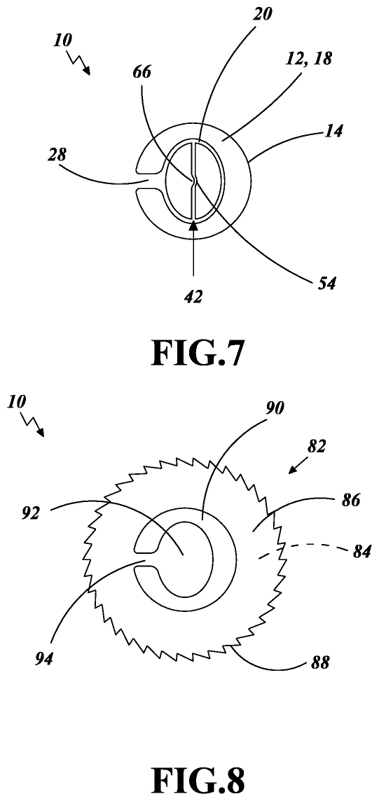

As shown in FIG. 7, inserted and maintained within cylindrical body 12, is wedge member 42 comprising first section 44 and second section 56. First section 44 comprises first end 46, along with second end, half-oval over surface, and inner surface (not shown), and cavity 54 located at the substantial center of first section 44. Second section 56 includes first end 58, along with second end, half-oval outer surface, and inner surface (not shown), and outward-extending tab 66 that is dimensioned and located to fit into cavity 54 of first section 44. First section 44 has first opening 68 and second opening 70, and second section 56 also comprises first opening 72 and second opening 74. It should be noted, that as with the first design, the second design wedge member 42 comprises two pieces that are held together by attachment means 76 which can comprise at least one screw, bolt, wire or other means, and attachment means 76 has a self-tapping (i.e., pointer) tip that passes through webbing 128 with the wedge member 42.

As shown in FIGS. 1, 2, and 8, located at one end of cylindrical body 12 is first ratchet gear 82 comprising inner surface 84, outer surface 86, perimeter teeth 88, center opening 90, and internal oval section 92 maintained in place by support arm 94 extending from an inner perimeter of center opening 90.

Located at an opposite end of cylindrical body 12 is second ratchet gear 100, also shown in FIGS. 1 and 2 with inner surface 102, outer surface 104, perimeter teeth 106, along with center opening and internal oval section maintained by support arm (not shown). Other than the fact that the first design has at least one ratchet gear, and the second design has a first and second ratchet gear, the functionality is the same for the ratchet gears in both design configurations. Also, both design configurations can be made of various materials such as metal or composite, or a combination of materials such as steel for the exterior and a high-strength polymer or alloy for the interior. Additionally, the lockout shaft interior, or a component such as the body may be various shapes.

Although the lockout shaft may be designed in many shapes, the oval shape of the wedge member overs specific advantages. When webbing is inserted into the lockout shaft and wrapped around the wedge member, the oval shape provides significantly increased strength/holding power to the webbing, when compared to a simple circular design.

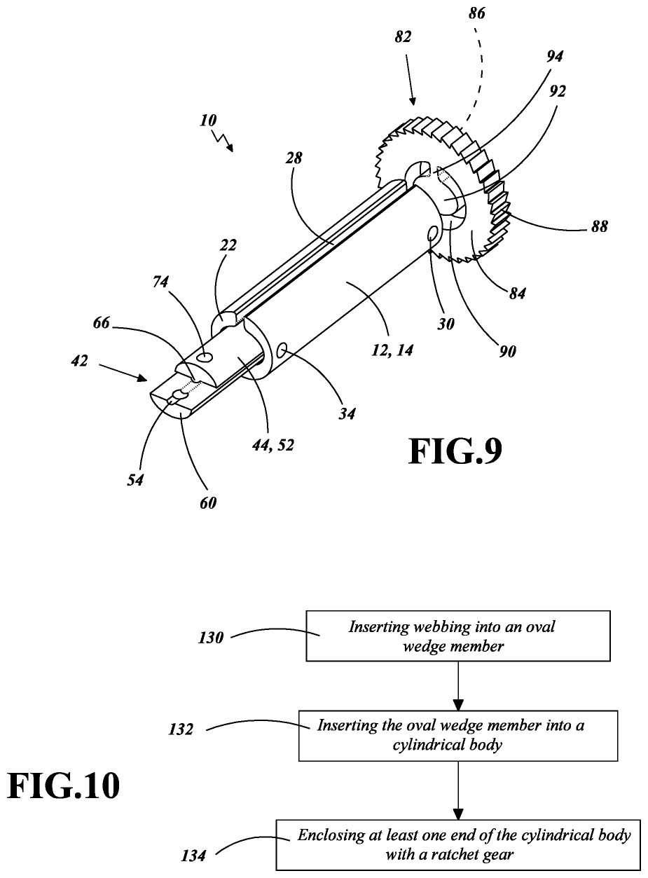

FIG. 9 provides a diagram of an example embodiment of lockout shaft 10 with the oval wedge member 42 and ratchet gear 82. Oval wedge member 42 includes first section 44 with cavity 54 and second section 56 with outward-extending tab 66. Second section 56 includes second section second opening 74. Webbing 128 (not shown) is first inserted between first section 44 and second section 56. Attachment means 76 (not shown) may be inserted into second section second opening 74 to secure first section 44 and second section 56 together. This also causes outward-extending tab 66 and cavity 54 to secure the webbing between first section 44 and second section 56. In an example embodiment, webbing 128 is wrapped around half of second section 56 so that it may exit slot 28 as oval wedge member 42 is inserted into oval opening 24 in lockout shaft 10. Hollow cylindrical body 12 may be have an oval, circular, or other geometric shaped outer surface. In an example embodiment the long axis of oval wedge member 22 is substantially perpendicular to slot 28.

In an example embodiment, ratchet gear 82 is enclosed around hollow cylindrical body 12. In an example embodiment, internal oval section 92 of ratchet gear 82 slides into oval opening 20 and support arm 94 slides into slot 28. Hollow cylindrical body 12 fits in center opening 90. In an example embodiment, at least one securing pin is inserted into one of bore 30, 32, 34, 36 on cylindrical body 12 to secure ratchet gear 82 in place.

FIG. 10 provides a flow diagram of an example embodiment of a method of securing webbing in a lockout shaft. In step 130, webbing is inserted into an oval wedge member, the oval wedge member comprising a half-oval first section comprising a cavity in a flat portion of the half oval first section and a half-oval second section comprising an outward-extending tab in a flat portion of the half-oval second section, the tab and cavity configured to secure the webbing between the first section and the second section. In step 132, the oval wedge member is inserted into a cylindrical body, the cylindrical body comprising a slot longitudinally extending from a first end of the cylindrical body to a second end of the cylindrical body, the slot configured to receive the webbing. In step 134, at least one end of the cylindrical body is enclosed with a ratchet gear.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

### PARTS LIST

10 Lockout Shaft
12 Hollow Cylindrical Body
14 Outer Surface
16 Inner Surface
18 First End
20 Oval Opening
22 Second End
24 Oval Opening
28 Slot (Long)
30 First End First Bore
32 First End Second Bore
34 Second End First Bore
36 Second End Second Bore
42 Oval Wedge Means
44 First Section
46 First End
48 Second End
50 Half-Oval Outer Surface
52 Inner Surface
54 Cavity
56 Second Section
58 First End
60 Second End
62 Half-Oval Outer Surface
64 Inner Surface
66 Outward-Extending Tab
68 First Section First Opening
70 First Section Second Opening
72 Second Section First Opening
74 Second Section Second Opening
76 Attachment Means
82 First Ratchet Gear
84 Inner Surface
86 Outer Surface
88 Perimeter Teeth
90 Center Opening
92 Internal Oval Section
94 Support Arm
100 Second Ratchet Gear
102 Inner Surface
104 Outer Surface
106 Perimeter Teeth
108 Center Opening
110 Internal Oval Section
112 Support Arm
118 Securing Pin (Ratchet Gear)
128 Webbing

1. A lockout shaft comprising:
a cylindrical body comprising a slot longitudinally extending from a first end of the cylindrical body to a second end of the cylindrical body, the slot configured to receive webbing;
an oval wedge member configured to fit in a hollow cavity of the cylindrical body, the oval wedge member comprising:
a half-oval first section comprising a cavity in a flat portion of the half oval first section; and
a half-oval second section comprising an outward-extending tab in a flat portion of the half-oval second section, the tab and cavity configured to secure the webbing between the first section and the second section; and
at least one ratchet gear configured to enclose one end of the cylindrical body.

2. The lockout shaft of claim 1, further comprising:
at least one bore adjacent to the first end, the bore configured to accept a securing pin to maintain the at least one ratchet gear in position on the cylindrical body.

3. The lockout shaft of claim 1, further comprising an attachment means for securing the half-oval first section to the half-oval second section.

4. The lockout shaft of claim 3, wherein the attachment means comprises at least one of a screw, a bolt, a pin, adhesive, a clamp, a strap, a band, wire, and welding.

5. The lockout shaft of claim 1, further comprising an oval cap configured to maintain the oval wedge member in the cylindrical body.

6. The lockout shaft of claim 5, further comprising a support arm connecting the oval cap to the at least on ratchet gear.

7. The lockout shaft of claim 1, wherein the webbing is wrapped around the oval wedge member such that a holding strength is at least equal to a strength of the webbing itself when the webbing is wrapped back onto and over itself.

8. The lockout shaft of claim 1, wherein the ratchet gear stops crushing or biting of the webbing within the cylindrical body slot.

9. A lockout shaft comprising:
a cylindrical body comprising a slot longitudinally extending from a first end of the cylindrical body to a second end of the cylindrical body, the slot configured to receive webbing;
an oval wedge member configured to fit in a hollow cavity of the cylindrical body, the oval wedge member comprising:
a half-oval first section comprising a cavity in a flat portion of the half oval first section; and
a half-oval second section comprising an outward-extending tab in a flat portion of the half-oval second section, the tab and cavity configured to secure the webbing between the first section and the second section;
a first ratchet gear configured to enclose one end of the cylindrical body; and
a second ratchet gear configured to enclose a second end of the cylindrical body.

10. The lockout shaft of claim 9, further comprising:
at least one bore adjacent to the first end; and
at least one bore adjacent to the second end, each of the two bores configured to accept a securing pin to maintain the first and second ratchet gears in position on the cylindrical body.

11. The lockout shaft of claim 9, further comprising an attachment means for securing the half-oval first section to the half-oval second section.

12. The lockout shaft of claim 11, wherein the attachment means comprises at least one of a screw, a bolt, a pin, adhesive, a clamp, a strap, a band, wire, and welding.

13. The lockout shaft of claim 9, further comprising a first oval cap configured to maintain the oval wedge member in the first end of the cylindrical body and a second oval cap configured to maintain the oval wedge member in the second end of the cylindrical body.

14. The lockout shaft of claim 13, further comprising a first support arm connecting the first oval cap to the first ratchet gear and a second support arm connecting the second oval cap to the second ratchet gear.

15. The lockout shaft of claim 9, wherein the webbing is wrapped around the oval wedge member such that the holding strength is at least equal to the strength of the webbing itself when the webbing is wrapped back onto and over itself.

16. The lockout shaft of claim 9, wherein the ratchet gear stops crushing or biting of the webbing within the cylindrical body slot.

17. A method of securing webbing in a lockout shaft, comprising:
inserting webbing into an oval wedge member, the oval wedge member comprising:
a half-oval first section comprising a cavity in a flat portion of the half oval first section; and
a half-oval second section comprising an outward-extending tab in a flat portion of the half-oval second section, the tab and cavity configured to secure the webbing between the first section and the second section;
inserting the oval wedge member into a cylindrical body, the cylindrical body comprising a slot longitudinally extending from a first end of the cylindrical body to a second end of the cylindrical body, the slot configured to receive the webbing; and
enclosing at least one end of the cylindrical body with a ratchet gear.

18. The method of claim 17, further comprising inserting an oval cap in the first end of the cylindrical body, the oval cap configured to maintain the oval wedge member in the cylindrical body.

19. The method of claim 17, wherein the webbing is wrapped around the oval wedge member such that a holding strength is at least equal to a strength of the webbing itself when the webbing is wrapped back onto and over itself.

20. The lockout shaft of claim 17, wherein the ratchet gear stops crushing or biting of the webbing within the cylindrical body slot.
